(19) United States
(12) Patent Application Publication
(10) Pub. No.: US 2005/0183454 A1
(43) Pub. Date: Aug. 25, 2005

(54) Glass material for use in press-molding and method of manufacturing optical glass elements

(75) Inventors: Hideki Mutou, lida-shi (JP); Takeshi Takahashi, Muang (TH); Shigeaki Ohmi, Tokorozawa-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HOYA CORPORATION, Tokyo (JP)

(21) Appl. No.: 10/741,003

(22) Filed: Dec. 22, 2003

(30) Foreign Application Priority Data
Jan. 8, 2003 (JP) 2003-002486

(51) Int. Cl. C03B 40/02

(52) U.S. Cl. 65/24; 65/26

(57) ABSTRACT

A method of manufacturing glass materials for press molding comprising a film-forming step in which hydrocarbon is fed into a reaction chamber containing a glass material and the fed hydrocarbon is thermally decomposed to form a carbon-based film on the surface of the glass material. In the film-forming step, a cycle comprising a sub-step of feeding and thermally decomposing hydrocarbon and a sub-step of subsequently evacuating the reaction chamber is conducted two or more times. A method of manufacturing optical glass elements comprising heat softening and press molding a glass material having on the surface thereof a carbon-based film obtained by the above manufacturing method. Provided is a glass material for press molding permitting the prevention of flaws and cracks during the molding of an optical glass element and permitting the prevention of fogging of the optical glass element following molding. Further provided is an optical glass element without flaws, cracking, or fogging obtained from such a glass material for press molding.

### TECHNICAL FIELD

The present invention relates to a method of manufacturing a glass material for use in press molding in which a carbon-based film is provided on a glass material that has been preformed to a prescribed shape, and to a method of obtaining optical glass elements by heat softening and then press molding the glass material for press molding obtained by the above manufacturing method. More particularly, the method of manufacturing optical glass elements of the present invention yields optical glass elements of prescribed surface precision and optical performance without requiring grinding and polishing after molding.

### BACKGROUND TECHNOLOGY

It is known to form a film comprised preliminary of carbon (carbon-based film) by a method such as vacuum deposition, sputtering, or ion plating on the surface of the mold or the glass material to prevent fusion of the glass to the molding surface of the mold in the course of heat softening a glass material and press molding it with a pressing mold of prescribed surface shape and surface precision (Japanese Unexamined Patent Publication (KOKAI) Showa No. 62-207726 (Patent Reference 1)). However, the apparatus used to form carbon-based films is elaborate and, for example, there are problems in that formation of the film by vacuum deposition is time-consuming and in that the film prepared by sputtering has directivity and is unsuitable for spherical glass materials.

Accordingly, as a means of solving such problems, Japanese Unexamined Patent Publication (KOKAI) Heisei No. 8-217468 (Patent Reference 2) describes the formation of an easily extensible and thin carbon film on the surface of a glass material with a simplified method by the thermal decomposition of acetylene. However, in the carbon-based film described in Patent Reference 2, there is a problem in that fogging tends to occur on the surface of the molded lens.

### SUMMARY OF THE INVENTION

Further, as is known to the present inventors, interaction between the glass and the surface of the mold during molding tends to damage the lens (flaws and cracks) in some types of glass (for example, lanthanum-based optical glass). To prevent this, it is conceivable to form a relatively thick carbon-based film on the surface of the glass material. Accordingly, the present inventors attempted to increase the exposure level of the glass material to the hydrocarbon by increasing the period of introduction of hydrocarbon gas or by increasing the partial pressure in the course of forming a carbon-based film by the method of Patent Reference 2. However, this resulted in an even greater degree of fogging.

Accordingly, the present invention has for its objects to provide a glass material for press molding permitting the prevention of flaws and cracks during the molding of an optical glass element and permitting the prevention of fogging of the optical glass element following molding; and to provide an optical glass element without flaws, cracking, or fogging obtained from such a glass material for press molding.

The present inventors examined the causes of fogging of the lens surface in lenses obtained by the method described in Patent Reference 1. As a result, they found that the highly reactive hydrogen (referred to hereinafter as “hydrogen radicals”) contained in the glass material reacted with the mold separation film material on the molding surface of the pressing mold during press molding, roughening the molding surface or causing microfusion to occur, resulting in fogging.

This investigation by the inventors further revealed that the larger the number of hydrogen radicals contained in the glass material, the greater the fogging that occurred; fogging was thus found to depend on the amount of exposure of the glass material to the hydrocarbon during film formation in the above-described method. That is, it was discovered that the number of hydrogen radicals incorporated into the glass material varied with the length of exposure and partial pressure of the hydrocarbon in the reaction chamber during film formation, and that this affected the degree of fogging.

The present invention was devised on that basis.

The present invention, which solves the above-stated problems, is as follows.
(1) A method of manufacturing glass materials for press molding comprising a film-forming step in which hydrocarbon is fed into a reaction chamber containing a glass material and the fed hydrocarbon is thermally decomposed to form a carbon-based film on the surface of the glass material;
   characterized in that in the film-forming step, a cycle comprising the sub-step of feeding and thermally decomposing a hydrocarbon and the sub-step of subsequently evacuating the reaction chamber is conducted two or more times.
(2) The manufacturing method according to (1) characterized in that the feeding of hydrocarbon is conducted to the reaction chamber which is set to a thermal decomposition temperature until the partial pressure of the hydrocarbon in the reaction chamber reaches a prescribed pressure.
(3) The manufacturing method according to (1) or (2) characterized in that the feeding of hydrocarbon into the reaction chamber is conducted so that a partial pressure of the hydrocarbon reaches greater than or equal to 20 torr but less than 100 torr.
(4) The manufacturing method according to any of (1) to (3) characterized in that the evacuation of reaction chamber is conducted until a total pressure in the reaction chamber reaches less than or equal to 0.5 torr.
(5) The manufacturing method according to any of (1) to (4) characterized in that the film-forming step is conducted while maintaining a temperature in the reaction chamber within a range of from 250 to 600° C.
(6) A method of manufacturing optical glass elements comprising heat softening and press molding a glass material having on the surface thereof a carbon-based film obtained by the manufacturing method according to any of (1) to (5).
(7) The manufacturing method according to (6) characterized in that the press molding is conducted with a pressing mold having a carbon-containing film on the molding surface thereof.

### BRIEF DESCRIPTION OF THE FIGURES

FIG. 1 shows the relation between the partial pressure of the hydrocarbon in the reaction chamber and the processing time ((a) shows the conditions of the present invention and (b) shows the conditions of conventional method).

According to the present invention, a glass material for press molding capable of preventing flaws and cracking during the molding of optical glass elements and capable of inhibiting fogging of optical glass elements after molding will be provided.

According to the present invention, an optical glass element free of flaws, cracking, and fogging that is obtained from such glass materials for press molding will be provided as well.

### BEST MODE OF IMPLEMENTING THE INVENTION

[Method of Manufacturing Glass Materials for Press Molding]

The method of manufacturing glass materials for press molding of the present invention comprises the film forming step in which a hydrocarbon is fed into a reaction chamber containing a glass material and the fed hydrocarbon is thermally decomposed to form a carbon-based film on the surface of the glass material.

The film-forming step is characterized in that a cycle comprising the sub-step of feeding and thermally decomposing a hydrocarbon and the sub-step of subsequently evacuating the reaction chamber is conducted two or more times.

In the film-forming step of the manufacturing method of the present invention, a hydrocarbon gas is introduced into a reaction chamber containing a glass material and the glass material comes into contact with the hydrocarbon gas. The thermally decomposed hydrocarbon gas breaks down into carbon and hydrogen in the vicinity of the surface of the glass material and the carbon deposits on the surface of the glass material, to form a carbon-based film.

In the manufacturing method of the present invention, a cycle comprising the sub-step of feeding a hydrocarbon, thermally decomposing the hydrocarbon, and causing the carbon to deposit on the surface of the glass material and the sub-step of evacuating the reaction chamber following thermal decomposition to discharge the undecomposed hydrocarbon remaining in the reaction chamber and the hydrogen produced by decomposition is repeated. This cycle, conducted at least twice, may be repeated the number of times that is suitably determined in consideration of the thickness of the carbon film to be deposited on the surface of the glass material, the amount of hydrocarbon gas fed into the reaction chamber during each sub-step, and the like.

An amount of hydrocarbon fed into the reaction chamber in each sub-step is desirably such that the partial pressure of hydrocarbon falls within a range of greater than or equal to 20 torr and less than 100 torr, preferably a range of from 20 to 50 torr, since hydrocarbon of adequate partial pressure arrives and thermally decomposed at the surface of the glass material, which will yield good film-forming efficiency. However, a partial pressure of hydrocarbon may be selected outside the above-stated range in consideration of the type of glass employed, the shape of the optical element being molded, or the like.

Further, the hydrocarbon can be introduced into the reaction chamber at a constant flow rate until the partial pressure of the hydrocarbon reaches the above-stated range.

Further, evacuation of the reaction chamber is conducted by discharging so as to reduce the partial pressure of hydrocarbon and hydrogen. Evacuation to a gas pressure of less than or equal to 0.5 torr in the reaction chamber is desirable from the perspective of substantially inhibiting the generation of hydrogen radicals, as set forth further below.

When initially introducing a hydrocarbon gas into the reaction chamber, it is desirable that the reaction chamber is evacuated in advance. Following this evacuation, it is desirable to introduce an inert gas such as nitrogen, evacuate the reaction chamber again, and then conduct the first thermal decomposition.

The temperature of the reaction chamber in the film-forming step is desirably maintained at or above a certain level during the sub-step of feeding of hydrocarbon gas, and the thermal decomposition, and the sub-step of evacuation from the perspective of allowing thermal decomposition of the hydrocarbon to progress at a suitable rate on the surface of the glass material.

Prior to initial introduction of the hydrocarbon, the interior of the reaction chamber is desirably preheated to the thermal decomposition temperature.

That is, from the perspective of film-formation efficiency, hydrocarbon is desirably fed into a reaction chamber set to the thermal decomposition temperature until the partial pressure of the hydrocarbon in the reaction chamber reaches a prescribed pressure.

The temperature in the reaction chamber is set to one that is suited to the thermal decomposition of the particular type of hydrocarbon. For example, this temperature suitably falls within a range of from about 250 to 600° C. Examples of hydrocarbons suitable for use are: acetylene, ethylene, butane, ethane, propyne, propane, and benzene. When acetylene is employed as the hydrocarbon, a suitable temperature for thermal decomposition is from 400 to 550° C., preferably from 480 to 510° C. Acetylene is one of the desirable hydrocarbons due to its relatively low thermal decomposition temperature.

The hydrocarbon is desirably of high purity, with a purity of greater than or equal to 99.6 percent being preferable from the perspective of preventing staining or fogging of the glass (reactions between impurities and the glass). For example, when a high-purity (purity of 99.999 percent) hydrocarbon is employed, the effect of the present invention is achieved in more marked fashion. However, the effect of the present invention is still achieved with ones other than the high-purity hydrocarbon.

In the present invention, a cycle comprising the sub-step of feeding and thermally decomposing a hydrocarbon and the sub-step of subsequently evacuating the reaction chamber is repeatedly conducted at least twice (two cycles). This cycle may be repeated, for example, from 2 to 20 times, and sometimes desirably from 2 to 14 times. The number of cycles can be varied to control the thickness of the carbon-based film formed on the surface of the glass material. In the present invention, the thickness of the carbon-based film formed on the surface of the glass material desirably falls within a range of from 0.7 to 2 nm.

For example, for a lanthanum-based optical glass, the cycle is desirably conducted from 4 to 20 times. In the case of a barium borosilicate glass, the cycle is desirably conducted from 2 to 8 times.

In the film-forming step of the present invention, the thermal decomposition reaction time (the sub-step in which the hydrocarbon is fed and thermally decomposed) per cycle is from 10 to 200 minutes, desirably from 20 to 100 minutes, and preferably from 20 to 50 minutes. The time employed in the evacuation sub-step is desirably kept to 10 minutes or less from the perspective of suppressing exposure to hydrogen.

In conventional methods, a prescribed amount (the amount required to form a carbon-based film of prescribed thickness) of hydrocarbon gas is introduced into an evacuated reaction chamber, after which the introduction of hydrocarbon gas is stopped In that state, the hydrocarbon is thermally decomposed to complete film formation. By contrast, in the method of the present invention, as set forth above, a cycle comprised of a sub-step in which a hydrocarbon is fed and thermally decomposed and a sub-step in which the reaction chamber is evacuated following thermal decomposition is conducted at least twice. As a result, as described in detail in the embodiments below, when an amount of hydrocarbon (flow rate per unit time×processing time) equal to that of conventional methods is employed, the glass material upon which a film-forming is conducted by the method of the present invention, when employed in press molding, affords substantial improvement over conventional methods with regard to preventing fogging; and flaw and crack prevention effects are equal to or better than those achieved when employing glass materials obtained by conventional methods.

The fogging accompanying pressing is primarily due to fusion and surface roughening of the molding surface caused by the reaction of hydrogen radicals present in the glass with components (such as when carbon is contained in the mold-separating film) of the mold-separating film on the molding surface primarily during the pressing step, as set forth above. The hydrogen radicals in the glass are produced by thermal decomposition processing of hydrocarbon and absorption into the glass of hydrogen present in the atmosphere. The amount of hydrogen radical present in the glass depends on the total quantity of exposure of the glass to a hydrogen atmosphere. This total quantity of exposure is thought to depend on the total quantity of exposure to hydrocarbons.

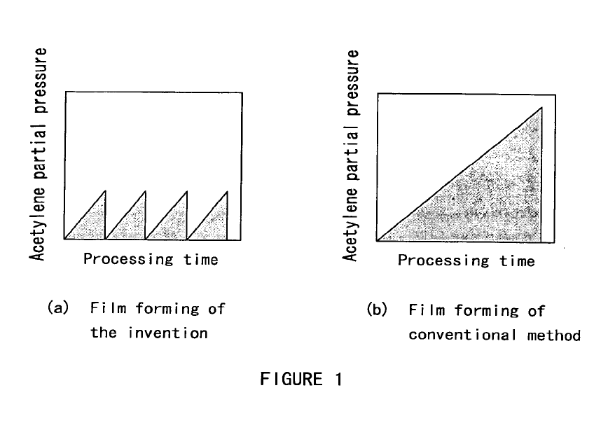

The total quantity of exposure to hydrocarbons can be denoted as the area of the relation between the processing time and the partial pressure of hydrocarbons in the reaction chamber, as shown in FIG. 1((a) being the conditions of the present invention and (b) being the conditions of conventional method). Accordingly, as the partial pressure of hydrocarbons increases, the amount of hydrogen radicals picked up by the glass sharply increases. The present inventors have attributed this to migration of hydrogen radicals to the molding surface during molding and subsequent reaction at the molding surface.

The amount of hydrogen radicals that have been picked up by the glass can be determined with glass materials into which a trace amount of Ag⁺ has been introduced by forming a carbon-based film by thermally decomposing a hydrocarbon and then measuring change in the color of the glass. The hydrogen that has penetrated into the glass reduces the Ag⁺, causing the glass to change from clear to yellow.

The quantity of carbon (quantity of surface carbon) in the carbon-based film formed on the surface of the glass material increases as the hydrocarbon decomposition reaction (for acetylene: C₂H₂→2C+H₂) progresses at the surface of the glass. Since this reaction is a surface reaction, it is strongly dependent on the surface state of the glass (in particular, on the number of carbon nuclei serving as base points for the above decomposition reaction). That is, when the above cycle is repeated in the method of the present invention, the quantity of surface carbons does not depend on the total quantity of exposure to the hydrocarbon. When the partial pressure of the hydrocarbon is intermittently changed, it is effectively enhanced. Since the generation of carbon nuclei takes place with precedence over the growth of carbon nuclei when the partial pressure of hydrocarbon at the surface of the glass is within a relatively low prescribed range, such a cycle is thought to increase the carbon nuclei at the surface and produce a uniform, dense film. As a result, the glass material obtained by the method of the present invention is thought not to readily develop flaws or cracks during press molding.

The composition of the glass material on which a carbon-based film is formed by the manufacturing method of the present invention is not specifically limited. For example, barium borosilicate optical glasses and lanthanum-based optical glasses may be effectively employed. In particular, a marked effect is achieved in lanthanum-based optical glasses, which tend to crack readily and fog over.

For example, as the barium borosilicate optical glass, an optical glass comprising the components:
30 to 55 wt % SiO₂,
5 to 30 wt % B₂O₃,
where the total amount of SiO₂ and B₂O₃ is from 56 to 70 wt % and the weight ratio of SiO₂/B₂O₃ is from 1.3 to 12.0,
7 to 12 wt % Li₂O (excluding 7 wt %),
0 to 5 wt % Na₂O,
0 to 5 wt % K₂O,
where the total amount of Li₂O, Na₂O, and K₂O is from 7 to 12 wt % (excluding 7 wt %),
10 to 30 wt % BaO,
0 to 10 wt % MgO,
0 to 20 wt % CaO,
0 to 20 wt % SrO,
0 to 20 wt % ZnO,
and characterized in that the total amount of BaO, MgO, CaO, SrO, and ZnO is from 10 to 30 wt %, the total amount of SiO₂, B₂O₃, Li₂O, and BaO in the above glass components is greater than or equal to 72 wt %, and no TeO₂ is contained, may be suitably employed.

Examples of the lanthanum-based optical glass includes an optical glass having the components of, given as weight percentages: 25 to 42 percent B₂O₃, 14 to 30 percent La₂O₃, 2 to 13 percent Y₂O₃, 2 to 20 percent SiO₂, more than 2 percent and less than or equal to 9 percent Li₂O, 0.5 to 20 percent CaO, 2 to 20 percent ZnO, 0 to 8 percent Gd₂O₃, 0 to 8 percent ZrO₂, 0.5 to 12 percent Gd₂O₃+ZrO₂, with the total content of these components being greater than or equal to 90 percent, and in some cases, further containing 0 to 5 percent Na₂O, 0 to 5 percent K₂O, 0 to 5 percent MgO, 0 to 5 percent SrO, 0 to 10 percent BaO, 0 to 5 percent Ta₂O₅, 0 to 5 percent Al₂O₃, 0 to 5 percent Yb₂O₃, 0 to 5 percent Nb₂O₅, 0 to 2 percent As₂O₃, and 0 to 2 percent Sb₂O₃.

The glass material may be a so-called glass preform that has been preliminary shaped out of a certain weight of glass melt. The shape may be spherical, oblate, or the like, and is not limited.

[Method of Manufacturing Optical Glass Elements]

The method of the present invention, in which a glass material on which a carbon-based film has been formed that has been obtained by the method of manufacturing glass materials of the present invention is heat softened and press molded to obtain an optical glass element, will be described below.

The press molding conducted in the manufacturing method of the present invention is conducted with, for example, an upper mold and a lower mold having molding surfaces that is opposite to a glass material prepared by processing a heat softened glass material into a necessary lens shape and surface state, and with a guide mold for holding the upper mold and the lower mold at required positions. Specifically, the glass material is held between upper and lower molds held by a guide mold, the molds and glass material are maintained at a necessary temperature above the glass softening point, and the upper mold is pressed downward to shorten the distance between the upper mold and lower mold to a specified amount to mold, the mold is cooled along with the molded article, and the molded article is removed to obtain, for example, a desired glass lens.

An example of a recommended temperature range for press molding of a lens material is 530 to 680° C.; the actual temperature may be suitably selected based on the type of glass, the lens shape, and the like. A glass material having a carbon-based film is heated to this temperature and softened. The temperature of the upper mold, lower mold, and guide mold can be the same temperature as the glass material during pressing. When a suitable means of preheating the glass material alone outside the mold is employed, press molding can be conducted with the upper mold, lower mold, and guide mold at a lower temperature than the glass material. In that case, the temperature of the glass mold is desirably made higher than the temperature employed in isothermal pressing methods in which the glass material and mold temperatures are identical. For example, a temperature corresponding to a glass material viscosity of 10^{5.5} to 10⁹ poises is desirable. By contrast, the mold temperature desirably corresponds to a glass material viscosity of 10⁷ to 10¹² poises.

Although the pressing mold is not specifically limited, a pressing mold obtained by processing to desired shape SiC that has been produced by CVD, for example, and forming a mold-separating film in the form of a thin carbon-containing film on the molding surface facing the glass material, is desirably employed. In addition to SiC, it is also possible to employ Si₃N₄, Mo, and the like. Depending on the type of glass and the shape of the lens, it is possible to employ a thin carbon film formed by sputtering, a thin carbon film formed by ion plating, and a double-structure thin carbon film obtained by forming a thin carbon film by sputtering over a thin carbon film formed by ion plating. Thin carbon films formed by sputtering afford the advantage of good mold separating properties with lenses following molding. Thin carbon films formed by ion plating afford the advantages of good adhesion to the mold and a faithful transferal of the shape of the pressing mold to the glass material. Double-structure thin carbon films obtained by forming a thin carbon film by sputtering over a thin carbon film formed by ion plating afford the advantages of good adhesion to the mold and good mold separation from the lens after molding.

The shape of the optical element molded by press molding is not specifically limited. The present invention produces a marked effect in concave meniscus lenses and lenses with edge thicknesses of less than or equal to 1 mm. The cracking and fogging that tend to occur at molding temperatures of greater than or equal to 600° C., particularly greater than or equal to 650° C., are effectively prevented by the present invention.

Depending on the application of the optical glass element, it is possible not to remove the carbon-based film on the surface of the glass material following press molding. However, there are cases where its removal is desirable.

Removal of the carbon-based film from the optical glass element can be done by, for example, heating at about 300° C. in an oxidizing atmosphere (for example, in air). However, this method and condition is not intended as a limitation.

### EMBODIMENTS

The present invention is described in greater detail below through embodiments.

### Embodiment 1

Oblate glass preforms of lanthanum-based optical glass M-NbFD13 (made by HOYA (Ltd.)) were placed on a quartz tray and positioned within a bell jar (reaction chamber). The interior of the bell jar was evacuated with a vacuum pump to below 0.5 torr and maintained at 480° C. with heating. While introducing nitrogen gas into the bell jar, evacuation was conducted by the vacuum pump to maintain 160 torr, and after conducting a 30 minute purge, the introduction of nitrogen gas was stopped.

Next, the interior of the bell jar was evacuated to below 0.5 torr with the vacuum pump, acetylene gas was introduced for 30 minutes at a constant flow rate, and when the pressure within the bell jar reached 30 torr, the introduction of acetylene gas was halted and the interior of the reaction chamber was immediately evacuated by the vacuum pump. When the reaction chamber fell below 0.5 torr (five minutes of evacuation), the introduction of acetylene gas was begun anew.

This operation was conducted four times (four cycles), the reaction chamber was cooled, atmospheric pressure was restored while diluting with nitrogen gas, and the glass preform was recovered.

The glass preform thus obtained was employed, and a pressing mold made of SiC having a molding surface, which is opposite the glass material, and upon which a thin carbon film had been formed by sputtering was employed. The glass preform was kept at a temperature of 650° C. (corresponding to a glass viscosity of 10⁷ poises) between upper and lower molds accompanied by a guide mold, and then pressed with a mold pressure of 100 kg/cm² to mold a concave meniscus lens 18 mm in diameter.

Following lens molding, annealing was conducted in air for 2 hours at 490° C. and the carbon film on the lens surface was removed.

Flaws, cracks, and fogging due to fusion of the lens to the molding surface during press molding were evaluated. The results are given in Table 1. As shown in Table 1, flaws, cracks, and lens fogging were prevented.

Flaws, cracks, and fogging were evaluated as follows.

Flaws were evaluated as the ratio of samples in which flaws were observed by stereomicroscope (10-fold magnification). Cracking and fogging were evaluated as the ratio of samples in which their occurrence was detected by visual examination.

### COMPARATIVE EXAMPLE 1

Glass preforms (identical to those in Embodiment 1) of lanthanum-based optical glass M-NbFD13 (made by HOYA (Ltd.)) were placed on a quartz tray which was then positioned on a rack in a bell jar. After evacuating the interior of the bell jar to below 0.5 torr with a vacuum pump, the glass preforms were maintained at 480° C. with heating. While introducing nitrogen gas into the bell jar, evacuation was conducted by the vacuum pump to maintain 160 torr. Following a 30 minute purge, the introduction of nitrogen gas was stopped.

After evacuating the interior of the bell jar to below 0.5 torr with the vacuum pump, acetylene gas was introduced for 120 minutes at a constant flow rate to 120 torr, at which point the introduction of acetylene gas was halted. Next, the reaction chamber was cooled, atmospheric pressure was restored while diluting with nitrogen gas, and the glass preforms were recovered.

Employing these glass preforms, concave meniscus lenses were press molded with procedures similar to those of Embodiment 1. Table 1 gives the evaluation results for the lenses obtained. As shown in Table 1, although flaws and cracks were prevented, the rate of fogging was nearly three-fold that of Embodiment 1 and the external appearance was defective.

### Embodiment 2

Glass preforms of optical glass (lanthanum based) M-LaC130 (made by HOYA (Ltd.)) were placed on a quartz tray and the tray was positioned on a rack in a bell jar. After evacuating the interior of the bell jar to below 0.5 torr with a vacuum pump, the glass preforms were maintained at 480° C. with heating. While introducing nitrogen gas into the bell jar, evacuation was conducted by the vacuum pump to maintain 160 torr. After conducting a 30 minute purge, the introduction of nitrogen gas has halted.

After evacuating the interior of the bell jar to below 0.5 torr with the vacuum pump, acetylene gas was introduced into the bell jar. When the pressure within the bell jar reached 30 torr after 30 minutes, the introduction of acetylene gas was halted and the interior of the reaction chamber was immediately evacuated by the vacuum pump. When the interior of the reaction chamber fell below 0.5 torr (five minutes of evacuation), the introduction of acetylene gas was begun anew.

This operation was conducted 14 times (14 cycles), after which the reaction chamber was cooled. Subsequently, while diluting with nitrogen gas, the reaction chamber was restored to atmospheric pressure and the glass preforms were recovered.

Convex meniscus lenses 17 mm in diameter were press molded from these glass preforms. The apparatus and pressing steps employed were identical to those in Embodiment 1. Table 2 gives the evaluation results for the lenses obtained. As shown in Table 2, while preventing flaws and cracks, fogging was greatly inhibited and lenses with good external appearance were obtained.

### COMPARATIVE EXAMPLE 2

Glass type M-LaC130 glass preforms (identical to those in Embodiment 2) were placed on a quartz tray and the tray was positioned on a rack in a bell jar. The interior of the bell jar was evacuated to below 0.5 torr by a vacuum pump, after which it was maintained at 480° C. with heating. While introducing nitrogen gas into the bell jar, evacuation was conducted by the vacuum pump to maintain 160 torr. After a 30 minute purge, the introduction of nitrogen gas was stopped.

After evacuating the interior of the bell jar to below 0.5 torr with the vacuum pump, acetylene gas was introduced to 420 torr over 420 min, at which point the introduction of acetylene gas was halted. After cooling the reaction chamber, it was restored to atmospheric pressure while diluting with nitrogen gas, and the glass preforms were recovered.

Convex meniscus lenses were press molded in the same manner as in Embodiment 2 from these glass preforms. As a result, as indicated by the evaluation results in Table 2, flaws and cracks due to fusion and the like were prevented, but the occurrence of fogging was about five-fold the level of Embodiment 2.

In Comparative Example 2, when the acetylene partial pressure was reduced to 210 torr to prevent fogging, flaws and cracks occurred in a high ratio.

Tables 1 and 2 below give the results of the above embodiments and comparative examples.

TABLE 1

| Item | Embodiment 1 | Comparative Example 3 |
|---|---|---|
| PF glass type | M—NbFD13 | |
| Lens shape | Concave meniscus | |
| Temperature | 480° C. | 480° C. |
| Acetylene gas partial | 0 → 30 torr | 0 → 120 torr |
| pressure | | |
| Number of | 4 cycles | 1 cycle |
| film-formation cycles | | |
| Film formation | 120 minutes | 120 minutes |
| processing time (total) | | |
| Results | | |
| Flaw and crack | 0% | 0% |
| occurrence rate | | |
| Fogging defective rate | 2.4% | 7.0% |

TABLE 2

| Item | Embodiment 2 | Comparative Example 2 |
|---|---|---|
| PF glass type | M—LaC130 | |
| Lens shape | Convex meniscus | |
| Temperature | 480° C. | 480° C. |
| Acetylene gas partial | 0 → 30 torr | 0 → 420 torr |
| pressure | | |
| Number of | 14 cycles | 1 cycle |
| film-formation cycles | | |
| Film formation | 420 minutes | 420 minutes |
| processing time (total) | | |
| Results | | |
| Flaw and crack | 0% | 0% |
| occurrence rate | | |
| Fogging defective rate | 15% | 70% |

1-7. (canceled)

8. A method of manufacturing glass materials for press molding comprising a step of forming a carbon-based film on the surface of a glass material, which step comprising; feeding hydrocarbon into a reaction chamber, which contains a glass material, to make the hydrocarbon thermally decompose to form carbon-based film on the surface of the glass material and evacuating the reaction chamber, wherein a cycle of said feeding and said evacuating is conducted two or more times.

9. The method of claim 8 wherein feeding of hydrocarbon is conducted to the reaction chamber, which temperature is set to a thermal decomposition temperature, until the partial pressure of the hydrocarbon in the reaction chamber reaches a proscribed pressure.

10. The method of claim 9 wherein feeding of hydrocarbon to the reaction chamber is conducted so that the partial pressure of the hydrocarbon reaches greater than or equal to 20 torr but less than 100 torr.

11. The method of claim 8 wherein the evacuation of the reaction chamber is conducted until a total pressure in the reaction chamber reaches less than or equal to 0.5 torr.

12. The method of claim 8 wherein the step of forming a carbon-based film is conducted while maintaining the temperature in the reaction chamber within a range of from 250 to 600° C.

13. A method of manufacturing optical glass elements comprising preparing a glass material having a carbon-based film on the surface thereof, and heat softening and press molding the glass material having the carbon-based film, wherein the carbon based film is formed by feeding hydrocarbon into a reaction chamber, which contains a glass material, to make the hydrocarbon thermally decompose to form carbon-based film on the surface of the glass material, and evacuating the reaction chamber, whereby a cycle of said feeding and said evacuating is conducted two or more times.

14. The method of claim 13 wherein the press molding is conducted with a pressing mold having a carbon-containing film on the molding surface thereof.
